(19) United States
(12) Patent Application Publication
(10) Pub. No.: US 2005/0045022 A1
(43) Pub. Date: Mar. 3, 2005

(54) Single-reed wind instrument

(76) Inventor: Duncan James Gillis, Ottawa (CA)

Correspondence Address: DUNCAN GILLIS, 1-320 WAVERLEY ST., OTTAWA, ON, K2P 0W3, CA

(21) Appl. No.: 10/922,858

(22) Filed: Aug. 23, 2004

(30) Foreign Application Priority Data
Aug. 25, 2003 (CA) 2,438,676

(51) Int. Cl. G10D 7/06

(52) U.S. Cl. 84/380 B

(57) ABSTRACT

The present invention is a hand-held musical pipe wind instrument in which sound is produced by the vibration of a single reed and which replicates the relative scales and tone-hole arrangement employed on the Scottish Highland bagpipe chanter. In its most basic embodiment, this wind instrument consists of a saxophone reed and mouthpiece attached to the upper end of a tube and a flaring bell or sole attached to the lower end of the same tube. In this basic embodiment, the tube comprises a plurality of holes, known as tone-holes, disposed at locations along the length of the tube, which in playing are opened and closed successively in predetermined configurations to achieve changes in musical pitch.

Priority regarding the invention outlined in this specification is claimed for the application filed with the Canadian Intellectual Property Office, Application No. 2,438,676.

### FIELD OF THE INVENTION

The present invention relates to the field of hand-held musical pipe wind instruments and, in particular to single-reed instruments and specifically to the family of instruments centered around Scottish bagpipes.

### BACKGROUND OF THE INVENTION

Both single-reed and double-reed hand-held pipe wind instruments are comprised of a pipe or instrument body fitted with a reed at one end and with a plurality of holes, herein referred to as tone-holes, disposed at predetermined locations along the length of said instrument body, which may be covered and uncovered by action of the player's fingers to effectively lengthen or shorten the resonant frequency of the instrument body, thereby producing differences in musical pitch.

Instruments played with a single-reed (sometimes referred to in the literature as a ‘beating’ reed) have been in use since prehistoric times throughout areas of Asia and Europe. Their modern incarnations, the saxophone and the clarinet, are well known and are, in fact, the predominant types currently available. Many folk versions, known in parts of Britain as hornpipes, were once popular but became completely extinct by the 19^{th} century. A small resurgence of interest in this latter type of instrument has lately produced replicas of the Welsh variety, copied from surviving examples and specifically suited to traditional Welsh music. In other developments unrelated to the hornpipe tradition, many versions of small keyless instruments, marketed as “pocket” saxophones or clarinets, or the like, have been manufactured, being suited generally to non-specific, popular music such as might be played on actual saxophones or clarinets.

In another family of reed instruments, the double-reeded melody-pipe section of the Scottish Highland bagpipe, known as the chanter, has been in use in its present form since at least the 18^{th} century. The past few years have seen numerous innovations, all retaining the same tone-hole arrangement as the traditional bagpipe chanter, yet demonstrating a need amongst bagpipers for new sounds and musical possibilities. These include the revival of the Scottish smallpipe, the Border bagpipe, and several types of electronic bagpipe.

Foreign patent documents that relate to the field of the present invention include the following U.S. Patent documents:

| | |
|---|---|
| 6031168 | Damm |
| 4539888 | Whelan |
| 1069200 | Starck |
| 464926 | Harsin |
| 3326073 | Tremaine |
| 4838141 | Gilbert |

and the following U.K. patent documents:

| | |
|---|---|
| GB2219122 | Grant |
| GB2240655 | Richard |

Other References:

Baines, A.: “Woodwind Instruments and their History.” (2^{nd} edition) William Clowes and Sons, LTD, London, 1962

The past 30 years has witnessed a groundswell in the area of traditional Celtic music. In the 21^{st} century, many popular groups of this genre are actively incorporating global and contemporary pop and jazz influences into their work. Due to this and to inspiration from the Irish tradition of several instrumentalists of differing types playing together in what is known as a session, many players of the Scottish Highland bagpipe are keenly interested in ways to apply their existing skill in multi-instrumental settings. The traditional form of the Scottish Highland bagpipe is unsuited to this new demand for two critical reasons. Firstly, it plays at about five times the volume of most other instruments being used in this context, making it entirely impractical in un-amplified situations. Secondly, the traditional bagpipe is pitched in a musical key that these other instrumentalists either cannot play in or can play in only with great inconvenience.

These obstacles have not been satisfactorily addressed by the aforementioned innovations and revivals. The Scottish smallpipe is often made in a key suitable for session-playing, however instead of being too loud, it is often found to be too quiet when more than two other musicians are playing. As well, many Highland pipers find its tone to be unexciting. The Border bagpipe answers the need for volume and a more exciting tone but has the considerable added complication of being operated with bellows as well as a bag. Both of these types of bagpipe have a delivery time of 6 months to 2 years and run at a cost of $2000 to $5000, which is more than twice the cost of an entry level Highland bagpipe and prohibitive for many pipers. Add to these factors an exponential increase in maintenance (for musicians who already maintain a set of Highland bagpipes) of the most infamously difficult instruments to maintain, and it will be seen that they do not satisfactorily address the need at hand for most pipers.

The various electronic bagpipes address the issues of both volume and pitch but with a considerable aesthetic sacrifice, both visually and tonally. The session tradition is based on acoustic un-amplified instruments and the blending of their complex and variable tones. From this point of view, the electronic bagpipe just doesn't fit in a session. While very useful in practice or amplified situations, its sound is monotone, quite obviously synthetic and unpleasing to many pipers. Therefore, the electronic bagpipe does not satisfy their need for a serious acoustic session instrument with a variety of tonal colors and nuance.

The present invention offers a viable acoustic session instrument for Highland pipers, which, due to its tone-hole arrangement, accommodates exactly the same fingering and technique that they are accustomed to using on the bagpipe. It possesses a novel, unique, colorful and variable tonal character, at a volume and pitch matched to other session instruments and at a delivery time and cost comparable to an ordinary Highland pipe chanter.

Manufacturers of other single-reed instruments, mainly unconcerned and unfamiliar with traditional Scottish music and Scottish bagpipe fingering and technique, are primarily focused on improvements to existing, known instruments such as the saxophone and clarinet. As such, a single-reed instrument which comprises a tone-hole arrangement corresponding to that of the Scottish Highland bagpipe is not obvious to persons of average skill in that field.

Alternatively, manufacturers of existing instruments with a tone-hole arrangement corresponding to that of the Scottish Highland bagpipe are mainly concerned with the perpetuation and refinement of the tone produced by double-reeds, principally in the context of the bagpipe chanter and the practice chanter. As such, an instrument which comprises a tone-hole arrangement corresponding to that of the Scottish Highland bagpipe but which is sounded with a single-reed is not obvious to persons of average skill in that field.

Therefore, an instrument of the present invention is obvious neither to manufacturers of conventional, existing single-reed instruments, nor to manufacturers of existing instruments with tone-hole arrangements corresponding to that of the Scottish Highland bagpipe.

A single-reed instrument with a tone-hole arrangement corresponding to that of the Scottish Highland bagpipe is unknown in the art.

Thus, by this invention, a tonal quality similar to a keyed, chromatic instrument such as the clarinet or the saxophone, is newly made available on an instrument of fingered (i.e. keyless) tone-holes, and whose tone-hole arrangement is the same as that found on the Scottish Highland bagpipe, allowing players of the latter to easily play this new instrument.

### SUMMARY OF THE INVENTION

It is one object of the present invention to provide a single-reed musical pipe wind instrument which allows for the sounding of a group of pitches, which said pitches have the same whole-tone and semi-tone relationships to one another, as those sounded on the Scottish Highland bagpipe, due to said invention comprising the same tone-hole arrangement, and thus the same fingering system, as conventionally comprised on the Scottish Highland bagpipe chanter.

It is a further object of the present invention to provide a single-reed musical pipe wind instrument which by comprising a tone-hole arrangement, and thus a fingering system, that correspond to those of the Scottish Highland bagpipe chanter, allows players of the latter to easily transfer their skill onto the present invention and achieve a completely new sound and musical outlet.

It is a further object of the present invention to provide an affordable and maintenance-free musical wind instrument which may be used by Scottish Highland bagpipers and others in multi-instrumental or session situations.

It is a further object of the present invention to provide an affordable and maintenance-free musical wind instrument to persons who do not play the Scottish Highland bagpipe but are interested in traditional Scottish music or in session playing.

It is a further object of the present invention to provide an alternative to the common practice chanter for beginners and experienced players with which to practice bagpipe music and technique.

The present invention is a hand-held musical pipe wind instrument in which sound is produced by vibration of a single-reed and which replicates the scales and tone-hole arrangement conventionally employed on the Scottish Highland bagpipe chanter. In its most basic embodiment, this wind instrument consists of a saxophone mouthpiece and reed attached to the upper end of a tube, and a flaring bell or sole attached to the lower end of the same tube. In this basic embodiment, the tube includes a plurality of holes which may be covered directly by fingers (hence fingered tone-holes) during playing, disposed at locations along the length of the tube and corresponding in arrangement to the arrangement of tone-holes of the predetermined Scottish bagpipe chanter.

In the drawings which form a part of this specification,

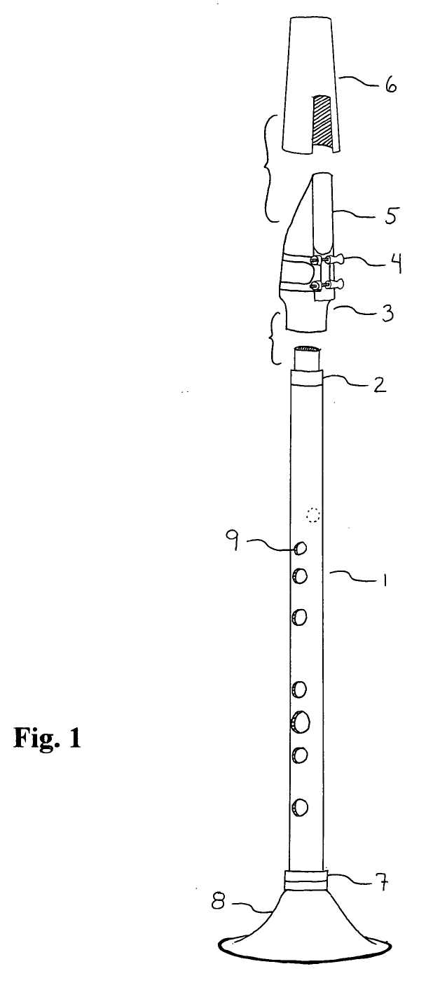

FIG. 1 is a view of the invention showing 7 tone-holes on its front and 1 tone hole on its back (in hidden lines).

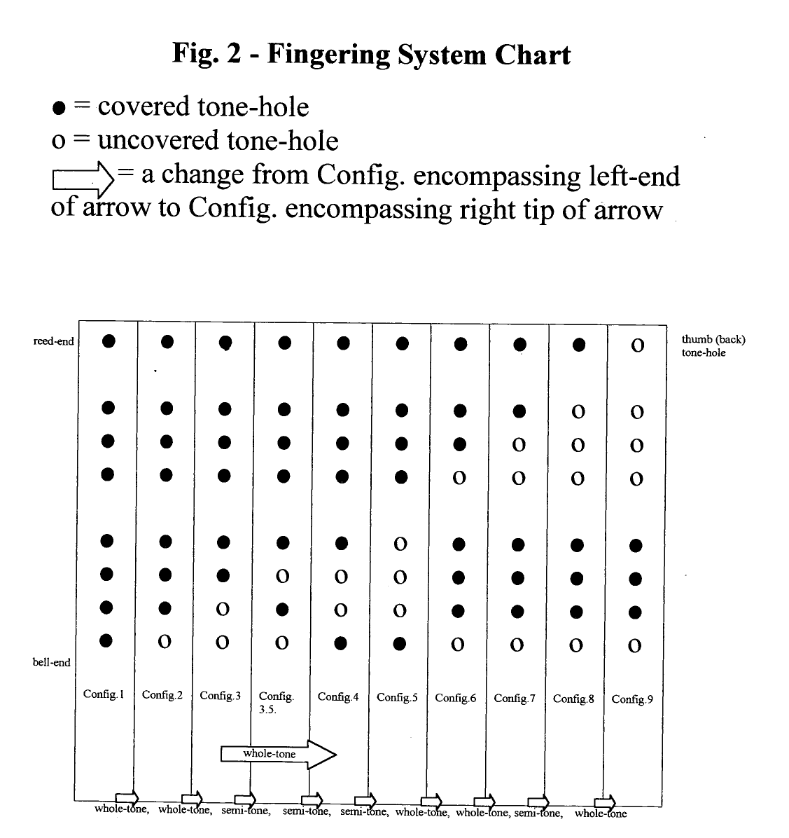

FIG. 2 is a fingering system chart showing the configurations of open and/or closed tone-holes which are comprised by the tone-hole arrangement of the instrument and the tonal distances between neighboring configurations.

### DETAILED DESCRIPTION OF THE INVENTION

Referring first to FIG. 1, an isometric view of the preferred embodiment of the single-reed wind instrument of the present invention is shown. This embodiment comprises a plastic body 1, having eight tone-holes 9, an ornamental metal ferrule 2, an alto saxophone mouthpiece 3 in exploded relationship to the instrument body, a mouthpiece ligature 4, an alto saxophone reed 5, a mouthpiece cover 6 in exploded relationship to the mouthpiece, a short connector pipe 7 and a metal bell 8.

The plastic mouthpiece 3, metal ligature 4 and cane reed 5 are of the type commonly available, however any type of mouthpiece apparatus or structure in combination with any type of single-reed could be used in other embodiments with similar results. One end of the instrument body 1 is sealably attached inside the mouthpiece 3 and the other end is sealably attached inside the upper end of the short connector tube 7. The lower end of the connector tube is sealably attached inside the narrow end of the bell 8. The instrument body 1 is ringed by the ornamental ferrule 2 at a distance from the mouthpiece-end of said body to allow for attachment of the mouthpiece 3.

With all parts assembled as described above, the instrument is sounded when air from the player is forced in and around the narrow, upper end of the reeded mouthpiece 3. Changes in musical pitch are accomplished by opening and closing the various tone-holes with the fingers, while the instrument is sounded, according to the fingering system chart in FIG. 2.

Thus, by comprising the same tone-hole arrangement as that of the Scottish Highland bagpipe, players of the latter instrument may easily play music on the present invention in multi-instrumental situations such as in a session.

A tone-hole arrangement is herein defined as a given musical pipe wind instrument's ability to sound a group of pitches which have specific predetermined whole-tone and semi-tone relationships to one another when employing any sequence of specific predetermined configurations of open and/or closed tone-holes, while the instrument is being blown. Another way of expressing this would be the sum total of said configurations of open and/or closed tone-holes which permits pitches with predetermined whole-tone and semi-tone relationships to one another to be sounded while the instrument is being blown.

It should be noted that the tone-hole arrangement of an instrument is not in itself the specific sizing and spacing of tone-holes on the instrument. These two elements can be at great variance on different embodiments or instruments and yet produce the same practical musical results. Rather, the sizing and spacing of tone-holes are the primary factors manipulated within quite a wide range of variability to achieve or give rise to the desired tone-hole arrangement. The essential characteristics of a tone-hole arrangement proper are precisely as defined above. Thus, two instruments comprising differing sizing and spacing of tone-holes nevertheless possess the same tone-hole arrangement if the resulting whole-tone and semi-tone relationships of pitches playable on each are the same when employing identical configurations of open and/or closed tone-holes.

In particular, with reference to FIG. 2, the tone hole arrangement of the present invention and that of the Scottish Highland bagpipe chanter, is one wherein changing from a

configuration of all fingered tone-holes covered, which shall be called Config. 1., while said instrument is properly sounded, to a configuration of all fingered tone-holes covered except the first fingered tone-hole from the lower end ( bell end ), which shall be called Config. 2, effects a change in pitch of exactly or approximately a whole-tone and

wherein changing from Config. 2, while said instrument is properly sounded, to a configuration of all fingered tone-holes covered except the first and second fingered tone-holes from the lower end, which shall be called Config. 3, effects a change in pitch of exactly or approximately a whole-tone and

wherein changing from Config. 3, while said instrument is properly sounded, to a configuration of all fingered tone-holes covered except the second and third fingered tone-holes from the lower end, which shall be called Config. 4, effects a change in pitch of exactly or approximately a whole-tone and

wherein changing from Config. 4, while said instrument is properly sounded, to a configuration of all fingered tone-holes covered except the second, third and fourth fingered tone-holes from the lower end, which shall be called Config. 5, effects a change in pitch of exactly or approximately a semi-tone and

wherein changing from Config. 5, while said instrument is properly sounded, to a configuration of all fingered tone-holes covered except the first and fifth fingered tone-holes from the lower end, which shall be called Config. 6, effects a change in pitch of exactly or approximately a whole-tone and

wherein changing from Config. 6, while said instrument is properly sounded, to a configuration of all fingered tone-holes covered except the first, fifth and sixth fingered tone-holes from the lower end, which shall be called Config. 7, effects a change in pitch of exactly or approximately a whole-tone and

wherein changing from Config. 7, while said instrument is properly sounded, to a configuration of all fingered tone-holes covered except the first, fifth, sixth and seventh fingered tone-holes from the lower end, which shall be called Config. 8, effects a change in pitch of exactly or approximately a semi-tone and

wherein changing from Config. 8, while said instrument is properly sounded, to a configuration of all fingered tone-holes covered except the first and eighth (the latter being located on the opposite side of instrument body) fingered tone-holes from the lower end, which shall be called Config. 9, effects a change in pitch of exactly or approximately a whole-tone.

wherein changing from Config. 3, while said instrument is properly sounded, to a configuration of all fingered tone-holes covered except the first and third fingered tone-holes from the lower end, which shall be called Config. 3.5, effects a change in pitch of exactly or approximately a semi-tone.

Thus, although the present embodiment of the invention plays primarily in a scale known as A mixolydian, which corresponds to D major, it will be apparent to persons of average skill in the field that embodiments of different lengths comprising differences in spacing and sizing of tone-holes will play in different scales and musical keys while nevertheless retaining the same configurations of open and/or closed tone-holes and tone-hole arrangement.

The present embodiment is designed to be blown directly by the player's mouth, however it is recognized that in other embodiments the inlet-end could be formed so as to be attached to an intermediary pipe or bag, so that the embodiment forms part of a more elaborate musical instrument such as a bagpipe.

In the present embodiment of the invention, the mouthpiece 3 which receives the single reed, is a part which is formed separately and connected to the instrument body 1. However, in other embodiments said mouthpiece could be formed integrally to said instrument body.

The instrument body 1 and connector tube 7 of the present embodiment are composed of acrylic plexiglass tubing. The bell 8 is composed of chrome plated steel. However, it will be apparent to persons of average skill in the field that, in other embodiments, said instrument body, connector tube and bell could be made of any type of wood, metal, plastic, polymer or other material with similar results. Furthermore, in another embodiment, the bell and/or connector tube sections of the present embodiment could be omitted altogether with similar results.

The single-reed 5 of the present embodiment is an alto saxophone reed, but it should be noted that many other types of single reed, (sometimes referred to as a beating reed), could be used in other embodiments. Some types of single-reeds actually possess multiple tongues on the same reed body. These are distinguished from double reeds by the fact that a double reed comprises two moving blades in physical contact which flex and straighten, in relation to each other, along their width when subjected to air pressure, whereas a single reed comprises a tongue which flexes and straightens along its length in relation to an stationary body. Such a body could have more than one tongue attached to it in different locations and would still be considered as being of single-reed technology.

The interior shape or bore of the instrument body 1 of the present embodiment is cylindrical, but it should be noted that other shapes of said bore, for example a conical shape, could be used in other embodiments to achieve variations in tonal character.

Although the present invention has been described in detail with reference to the preferred version thereof, other versions would be readily apparent to those of ordinary skill in the art. It is therefore desired that the invention not be limited to this embodiment and it is intended to cover in the appended claims all embodiments as fall within the true spirit and scope of the invention.

1. A musical pipe wind instrument comprising an elongated body, having an inlet at one end and an outlet at the opposite end of said body from said inlet, and further comprising a plurality of holes along the length of said body providing a tone-hole arrangement substantially the same as that of the Scottish Highland bagpipe chanter and wherein said inlet is adapted to receive a single-reed.

2. A musical pipe wind instrument as is claimed in claim 1 wherein the inlet defines a mouthpiece.

3. A musical wind instrument as is claimed in claim 1 or claim 2 wherein the tone-hole arrangement comprises in whole or in part, of seven tone-holes, positioned longitudinally along one side of the instrument body and one tone-hole positioned on the opposite side of said instrument body, closer to the inlet-end than are the former said tone-holes, and wherein all of said tone-holes must be covered and uncovered, during playing, directly by fingers as opposed to by any mechanical key apparatuses.

4. A musical wind instrument as is claimed in claim 3 which further comprises additional tone-holes which may be covered or uncovered by the use of mechanical keys.

5. A musical wind instrument as is claimed in claim 1 or claim 2 wherein the same series of exact or approximate whole-tone and semi-tone steps, from low pitch to high, are playable, at whatever pitches and in whatever musical key, as are playable on the Scottish Highland bagpipe chanter when employing the same specific configurations of open and/or closed fingered tone-holes, as are conventionally employed on said bagpipe chanter.

6. A hand-held single-reed wind instrument wherein musical scales in any musical key which correspond to Scottish bagpipe scales are produced when employing the same series of configurations of open and/or closed tone-holes as are conventionally employed to produce said corresponding scales on the Scottish Highland bagpipe chanter.

7. A musical wind instrument as is claimed in claim 6 wherein additional configurations of open and/or closed holes produce additional pitches.

8. A musical wind instrument as is claimed in claim 1 or claim 2 wherein the interior shape of the instrument body is conical or cylindrical.

9. A musical wind instrument as is claimed in claim 1 or claim 2 comprising a body made from acrylic plexiglass tubing.

10. A musical wind instrument as is claimed in any one of claims 1 to 9 which is adapted to receive a saxophone reed, clarinet reed, or bagpipe drone reed

11. A musical wind instrument as is claimed in any one of claims 1 to 10 further comprising a single-reed.

12. A musical wind instrument as is claimed in any one of claims 1 to 11 further comprising a saxophone reed, a clarinet reed or a bagpipe drone reed.

13. A musical wind instrument as is claimed in any one of claims 1 to 12 which can be played in and of itself or as part of a more elaborate musical instrument such as a bagpipe, for example.
